(19) United States
(12) Patent Application Publication
(10) Pub. No.: US 2014/0052781 A1
(43) Pub. Date: Feb. 20, 2014

(54) SYSTEMS AND METHODS FOR GATHERING AND SHARING TESTIMONIALS

(71) Applicant: Jason Matthew Dolle, Estero, FL (US)

(72) Inventor: Jason Matthew Dolle, Estero, FL (US)

(21) Appl. No.: 13/587,869

(22) Filed: Aug. 16, 2012

(51) Int. Cl. G06F 15/16

(52) U.S. Cl. 709/204

(57) ABSTRACT

A testimonial system that gathers, stores, and/or shares testimonials, comprising: an electronic testimonial-collection form that a client can fill out and submit to yield a completed testimonial; a database for storing the completed testimonial; and at least one means for the client, a service provider, the testimonial system, or combinations thereof to share the completed testimonial. In addition, a method for gathering, storing, and/or sharing testimonials, comprising the steps of: providing a testimonial-collection form; receiving a completed testimonial; storing the completed testimonials; and sharing the completed testimonial on at least one website.

### FIELD OF THE INVENTION

The present application relates generally to systems and methods for gathering and sharing testimonials. More specifically, the present application relates to systems and methods for electronically gathering and sharing testimonials via a service provider's website and/or a client's social media site.

### BACKGROUND OF THE INVENTION

When a service provider—such as a realtor, mortgage lender, or salesperson—engages with a prospective client, the prospective client may want to see work product from the service provider, especially if they have not previously worked with that service provider. However, for services, oftentimes there is no work product that can be physically, easily, or legally shared with a prospective client. In these situations, prospective clients often rely on word-of-mouth referrals or references provided by the service provider. A good testimonial from a previous client may lead to more business. But, it is often time-consuming, costly, and difficult for a service provider to collect testimonials. And once testimonials are collected, the service provider needs to figure out how to manage and display the testimonials for others to see. This can also be time-consuming, costly, and difficult to do.

In terms of gathering testimonials, there are many methods. Non-Internet-based methods may include things such as a service provider hosting a thank-you or networking event to try to lure past clients to attend so they may elicit testimonials. Or, a service provider may host a post-completion follow-up meeting with the client. Or, testimonials may be solicited via mail or telephone, such as with a customer satisfaction survey. The service provider itself typically memorializes such testimonials in sharable media. This can be time-consuming, costly, and difficult.

More recently, there are Internet-based methods for gathering testimonials. For instance, a company may have an automated system that sends out a survey or customer satisfaction email to past or current clients. Or, the service provider could just send out a personal email asking a client for feedback. But, it can be costly and time consuming for those independent or small service providers to create and update a web site with testimonials—for instance, every time a new testimonial is ready to be added to a web site, the service provider may need to contact a web developer to update the site with the new testimonial. This can also lead to outdated testimonials, which can often be worse for generating new business than no testimonials at all. In addition, collected testimonials may go unnoticed because they are simply static features on a service provider's web site. Unless a potential client is purposely navigating to the service provider's web site, potential clients may not see the service provider's testimonials.

Described above are current service-provider means for gathering and sharing testimonials. There are also client means for sharing testimonials. It is common to find short, unsolicited reviews (for products, services, restaurants, etc.) on the Internet. Often, these reviews are cursory or negative in nature—for example, a client venting their frustration with a service provider. It is less common for a client who is pleased with a service provider's results to go out of their way to post positive feedback on the Internet. Even if a client wanted to post about their experience with a service provider, there is not a good forum for publicly sharing their comments. There are many public websites where diners can review restaurants, where travellers can review hotels, or the like. And there are member-only websites where, for example, people can review house painters, doctors, and more. A service provider could maintain their own website with an avenue for clients to leave testimonials. However, there are no public, non-member-only websites specifically designed for the review and promotion of multiple small or independent service providers.

For the above reasons and more, it is hard to find thoughtful reviews of service providers, especially testimonials of independent or small service providers. It can be burdensome for service providers to track down past clients and ask them to provide useful feedback via the methods described above. And there is no fast and easy way for a satisfied client to share their positive experience with friends, family, co-workers, or the like.

There is a need for service providers to quickly and easily solicit and collect testimonials from past or present clients. Specifically, there is a need for a simple and non-bothersome way to ask current and past clients for their feedback and memorialize it electronically in a means sharable with prospective clients. And for prospective clients, there is a need for access to helpful and informative testimonials for service providers, and a need for testimonials from people they trust. It is desirable to create a system for sharing testimonials whereby a service provider may expend little effort or money to display the testimonials on their web site. There is a desire to have the testimonials act as advertising on sites other than just the service provider's web site, for instance, on social media sites. There is a need for a better, more modern word-of-mouth referral system.

While these are all objects of the invention, a particular embodiment of the invention need not meet all of these objects.

### SUMMARY OF THE INVENTION

The present invention relates to a testimonial system that gathers, stores, and/or shares testimonials, comprising: an electronic testimonial-collection form that a client can fill out and submit to yield a completed testimonial; a database for storing the completed testimonial; and at least one means for the client, a service provider, the testimonial system, or combinations thereof to share the completed testimonial.

In addition, the present invention relates to a method for gathering, storing, and/or sharing testimonials, comprising the steps of: providing a testimonial-collection form; receiving a completed testimonial; storing the completed testimonials; and sharing the completed testimonial on at least one website.

### BRIEF DESCRIPTION OF THE DRAWINGS

The accompanying drawings, which are incorporated into and constitute a part of this specification, illustrate embodiments of the invention, and, together with the detailed description of the invention provided below, serve to explain the principles of the invention.

FIG. 1 depicts a flow chart that illustrates a method for gathering and sharing testimonials as described herein;

FIG. 2 depicts an exemplary home page of an exemplary testimonial system as described herein;

FIG. 3 depicts an exemplary service-provider's-tools page of an exemplary testimonial system as described herein;

FIG. 4 depicts an exemplary testimonial request page of an exemplary testimonial system as described herein;

FIG. 5 depicts an exemplary testimonial-collection-form page of an exemplary testimonial system as described herein;

FIG. 6 depicts an additional exemplary testimonial-collection-form page of an exemplary testimonial system as described herein;

FIG. 7 depicts an exemplary testimonial-management page of an exemplary testimonial system as described herein;

FIG. 8 depicts an exemplary how-to-add-a-widget page of an exemplary testimonial system as described herein; and

FIG. 9 depicts an exemplary testimonial page on a service provider's website as described herein.

### DETAILED DESCRIPTION OF THE INVENTION

Both the foregoing general description and the following detailed description describe various systems and methods and are intended to provide an overview or framework for understanding the nature and character of the claimed subject matter.

### Definitions

As used herein, the terms “agent,” “real estate agent,” “referring agent,” “real estate party,” and “brokerage” can be used interchangeably.

As used herein, the terms “client” or “customer” mean a purchaser, recipient, and/or user of a service-provider.

As used herein, the term “service provider” means an individual, company, facility, or the like which provides a service or benefit to one or more clients. Examples of service providers include a real estate agent, lawyer, accountant, doctor, salesperson, house painter, teacher, massage therapist, hotel, hospital, restaurant, bar, or the like, and combinations thereof. When service provider is used herein in conjunction with a testimonial system, it can also refer to another individual, company, facility, or the like which uses the testimonial system on the service provider's behalf.

As used herein, the terms “social network,” “social media,” and the like mean an online (web or mobile) network of colleagues, friends, family, or special-interest groups; or a website that enables this virtual networking; or a highly social, scalable, and/or pushable online technology; or the like, and combinations thereof.

As used herein, the term “specialized link,” means a URL, link, or hyperlink that includes data relating to the contact information for a service provider and the identifier for a development website embedded therein. A specialized link is typically used in marketing efforts intended for use with the present invention, including, but not limited to: websites, email, print, television, billboards, etc. The specialized linking process requires cooperation by both the referring agent and the developer. The facilitator can typically provide a processing program, such as an application program interface, for the automation of this cooperation.

As used herein, the term “testimonial” means a statement testifying to a service provider's work product, character, rating, qualifications, timeliness, cost, or the like; or a statement testifying to a client's appreciation, satisfaction, benefits received, or the like; and combinations thereof. The statement may comprise a typed/written testimony, a video clip, a voice recording, or any other electronic communication format, and combinations thereof.

As used herein, the term “testimonial collection form,” “form,” or variation thereof refers to an electronic document or collection of form fields which can be filled-in by a client or service provider or the like.

As used herein, the term “testimonial system” means a website, application, program, database, or the like, which offers testimonial gathering, storing, and/or sharing services, or the like.

As used herein, the terms “URL” (Uniform Resource Locator), “link,” and “hyperlink” refer to the core concept/technology that allows the Internet to operate; a URL connects a webpage to either another document (webpage or file), or a different part of the same document, and can comprise, as a non-limiting example, a raw URL link, a name link, an icon link, or the like.

### Overview

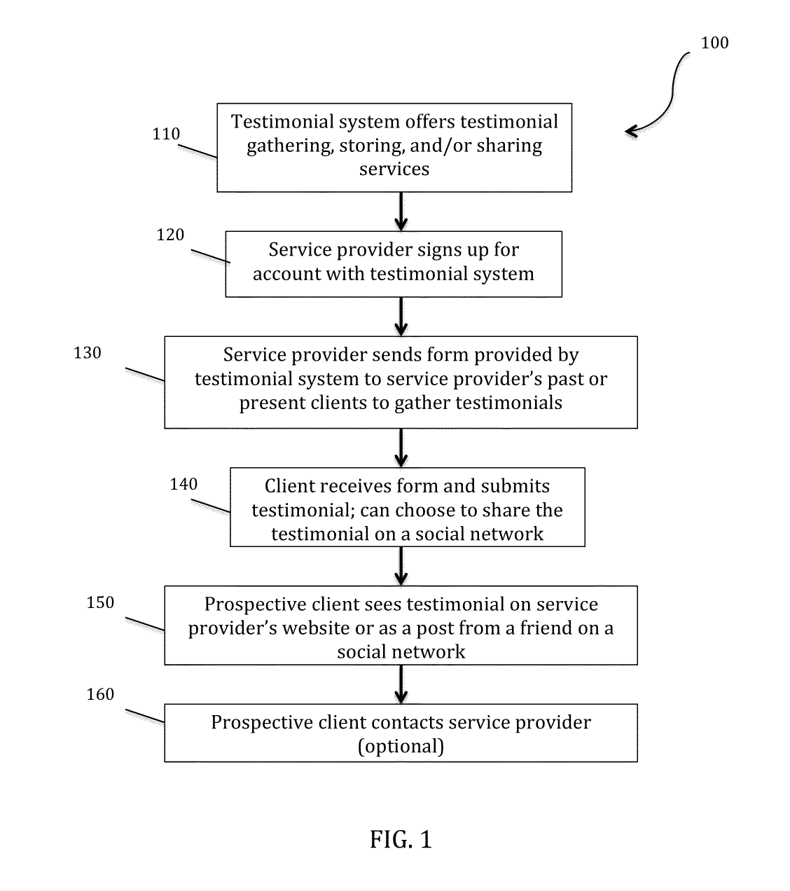

The systems and methods of the present invention enable more testimonials to be generated more frequently, either through a service-provider's website or through a client's own social network. Testimonials can be an extremely powerful marketing tool. This tool can be made even more powerful when clients share their testimonials on their social networks via the methods described herein. As shown in the flow chart of FIG. 1, the present method 100 allows a client to recommend a service provider to their friends and provide a link to the service-provider's website. The instant invention comprises a system for managing testimonials while harnessing the power of social media as a marketing channel 110. Asking clients to share testimonials through their social networks can quickly and easily bring a service-provider many new clients. Accordingly, the present invention comprises a testimonial system that offers testimonial gathering, storing, and/or sharing services. Preferably, the service is web-based.

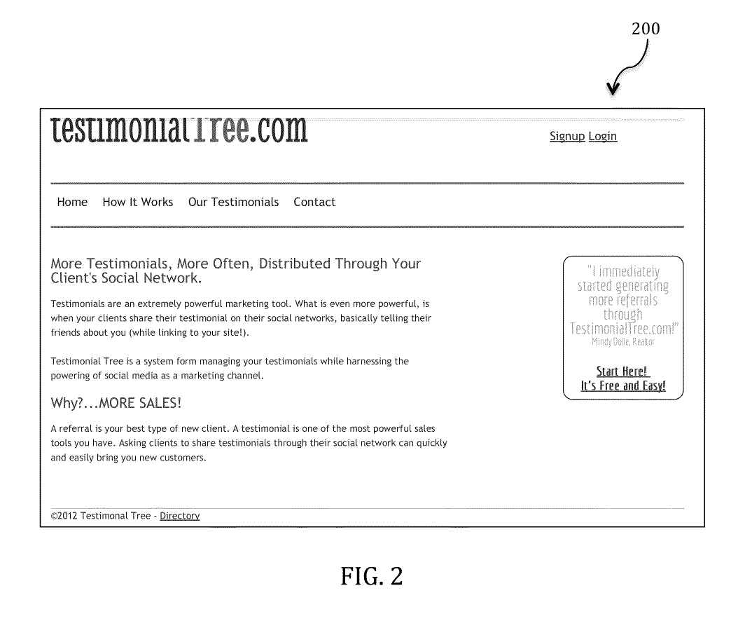

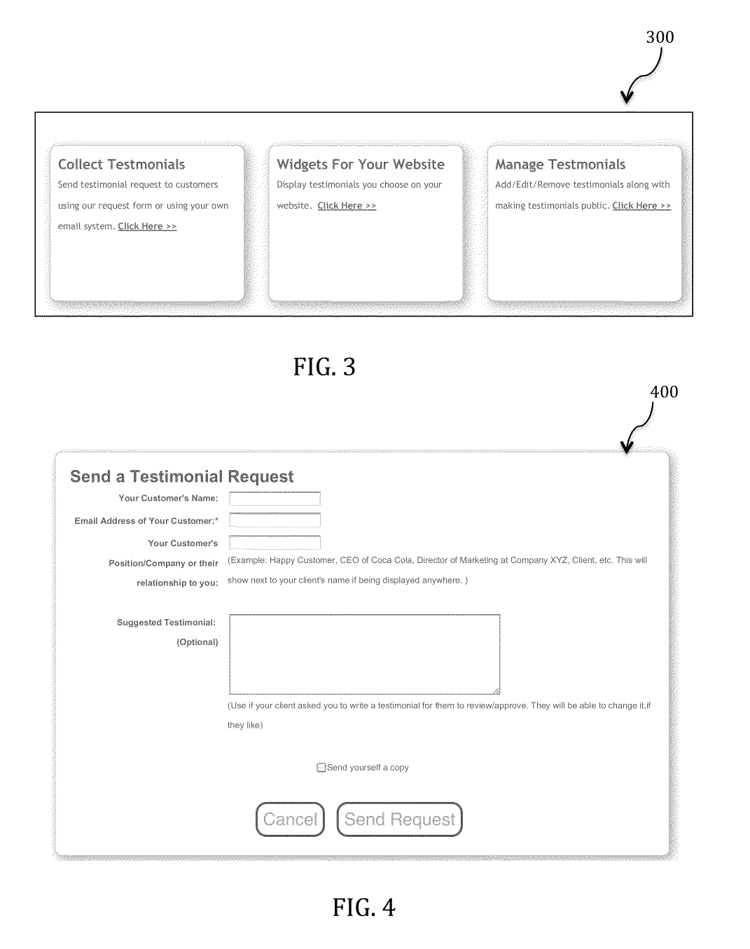

A service-provider signs up for an account 120 with a testimonial system 200, such as the one shown in FIG. 2. As shown in FIG. 3, the testimonial system 200 may comprise a service-provider's-tools page 300 allowing a service provider to collect testimonials, manage testimonials, learn how to add a testimonial feed to their own website via a widget, or the like.

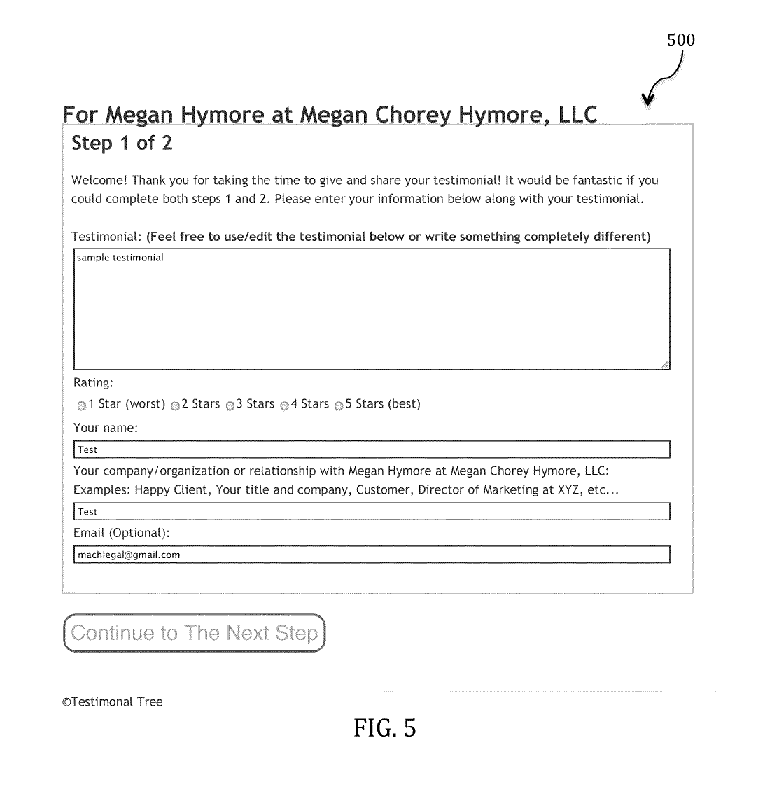

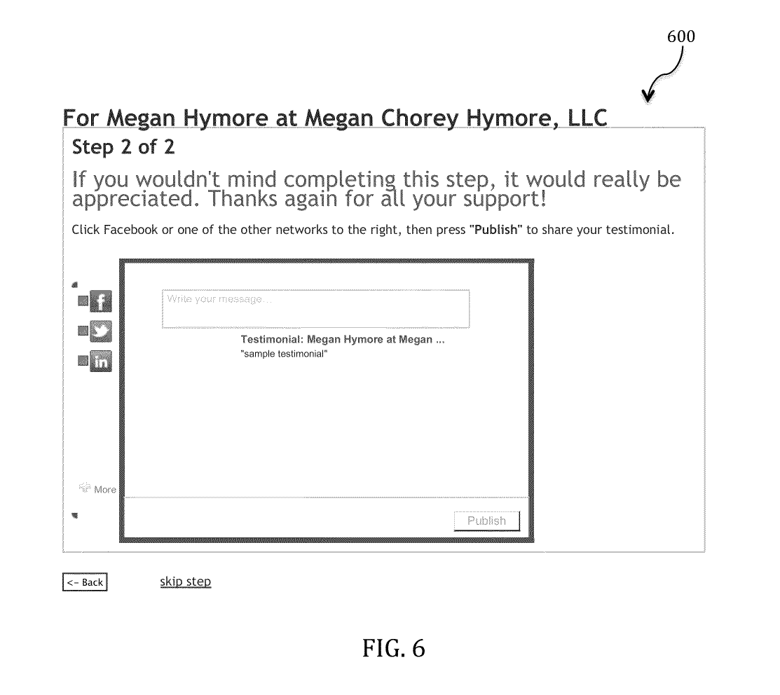

The testimonial system provides the service-provider with a testimonial request 400, as shown in FIG. 4, to send to past or present clients to thereby collect testimonials 130. An exemplary testimonial collection form 500,600 the client sees is shown in FIGS. 5 and 6. After the client submits a testimonial 140 via the form 500, they are asked to share the testimonial on at least one of the social networks to which they belong 600. Optionally, the testimonial system may allow the service provider to review and/or approve the testimonial before the client can share the testimonial on their network. By sharing the testimonial with a large audience, it increases the chances that a prospective client will see the testimonial 150. Once a prospective client sees the testimonial of their friend (the service provider's past or present client), the prospective client is more likely to trust the service provider, check out the service provider's website, and/or contact the service-provider than the prospective client would have been had their friend never posted a testimonial 160. So, the service-provider's site reaps increased traffic and exposure. Alternatively, or in addition, a service provider on their own site may share the collected testimonials. The testimonial system can provide tools for service providers to easily show and manage testimonials on the service provider's website. This can be done manually, or, the testimonial system can provide a widget which automatically updates the service provider's website when clients submit new testimonials. There can be various states of automation in this process; for instance, a testimonial may be routed for approval (by the service provider) prior to being posted via the widget. This gives the service provider some control over the testimonials being posted; for example, the service provider can decline to post a review that is not positive in nature.

### Gathering Testimonials

The testimonial system comprises different ways to send testimonial requests to clients. First, a service provider may send a testimonial request to a client via the system's form 400. An email will be sent to the client that has a link to the service provider's unique testimonial collection form 500 so the client can submit a testimonial, as shown in FIGS. 5 and 6. The testimonial collection form may comprise a text field where a testimonial may be written. The form may also comprise a system for quickly rating a service provider, for example, a 1-star to 5-star click-the-radio-button rating system. Optionally, the testimonial system can be set to disallow sharing a testimonial if a particular star level/threshold is not met. For instance, if the incoming testimonial doesn't meet a four star minimum rating, the client may not be prompted to share the testimonial on their social network, while if the incoming testimonial is a 4-star or 5-star, the system will prompt the client to share the testimonial.

The form 600 may give the client the ability to publish their testimonial (add an additional note) to one of their social networking sites, for example, Facebook®, LinkedIn®, Twitter®, or the like, or combinations thereof. Second, a service provider may use her own email system (Google®, Yahoo®, Outlook®, Constant Contact®, etc.) to send an email to a client and include (e.g., via copy and paste) a specialized link to the service provider's unique testimonial collection form. So, each service provider's unique testimonial collection form has its own specialized link or URL. The service provider may specifically request a testimonial from the client or a specialized link to the testimonial system can be part of the service provider's email signature. Third, a service provider may add previously-rendered testimonials manually.

An incentive system may be implemented as part of the testimonial system. The incentive system may encourage clients to fill out testimonial collection forms and/or share testimonials on their social network(s) by providing rewards such as points, coupons, gift cards, entry in a drawing, and combinations thereof.

Sharing and Managing Testimonials

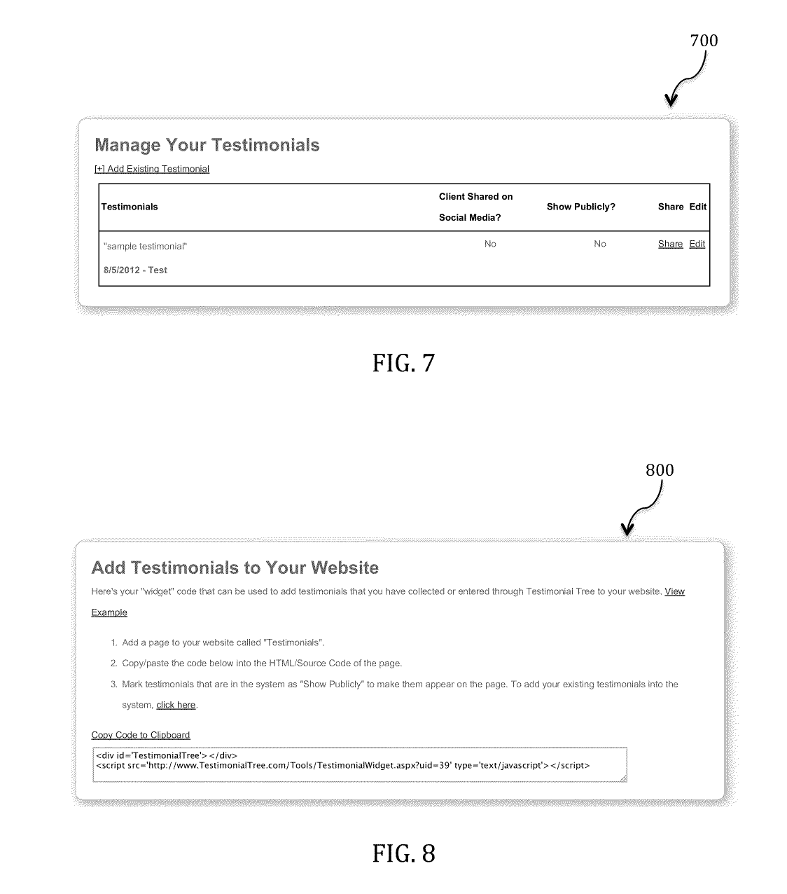

The testimonial system preferably comprises means to add, edit, and/or remove testimonials from a service provider's list of testimonials, as shown on the exemplary testimonial-management page 700 of FIG. 7. A testimonial may be marked to show publicly (e.g., on the service-provider's webpage or on the testimonial system's directory) or to not show publicly. The listing of testimonials can show whether or not the client shared the testimonial via social media.

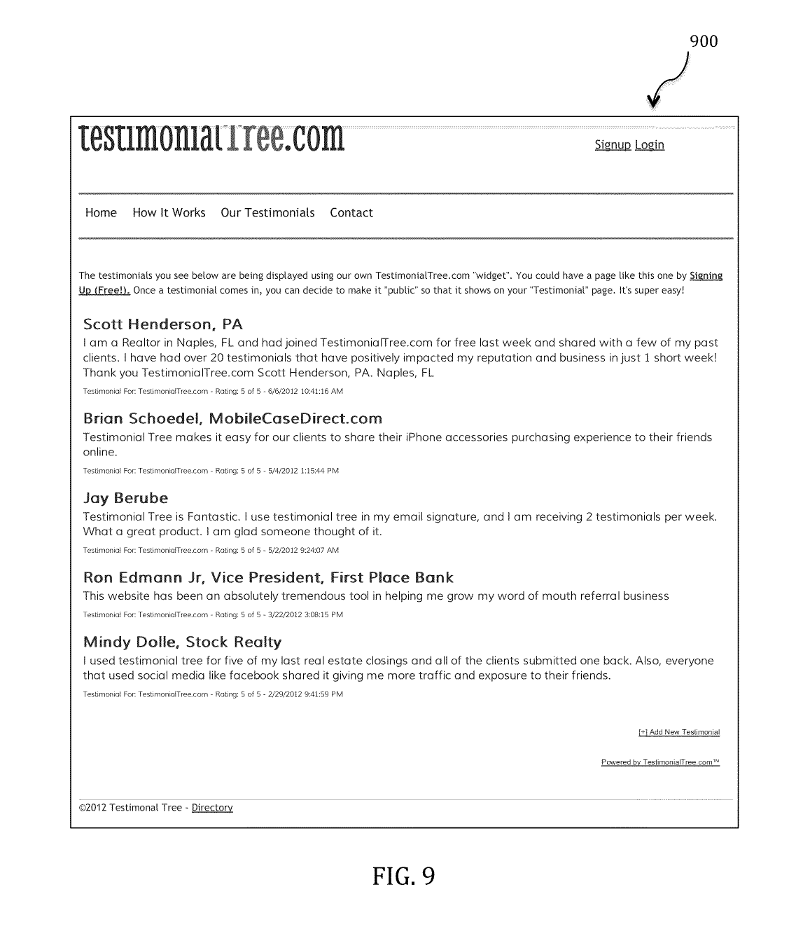

The testimonial system preferably comprises a widget that enables a service provider to display all testimonials or chosen testimonials on its website. FIG. 8 depicts an exemplary how-to-add-a-widget page 800. The service provider adds a page to their website called “testimonials” and copies and pastes code (e.g., a line or two of html code) to the page's source code. This will allow all testimonials marked public to appear on the testimonials page of the service-provider's website. FIG. 9 shows an exemplary testimonial page 900 on a service provider's website as described herein, which has been populated with the testimonial system widget. The testimonial system may comprise multiple different types of widgets enabling different testimonial displays for different types of electronic media. For example, when a testimonial comes in from a client, the service provider can choose to display the testimonial on one or more of the widgets they have created from the system.

Additionally, the testimonial system itself may compile all public testimonials and display them to the general public that visits the testimonial system site. The testimonials may be sorted, searched, filtered, or the like, in such a way to provide the general public with an informational source of testimonials from various service providers all on one site. Or, the testimonial system may comprise an interface that allows potential clients to see testimonials rendered by their friends, family, colleagues, etc. (who are clients of various service providers).

There are many ways to further enhance the usefulness of the testimonial system. The activation of a specialized testimonial system link may pass the data embedded therein to an Application Program Interface (API) for a variety of uses. The testimonial system can provide administrative access to testimonials, for instance, to categorize or tag testimonials (e.g., by individual, team, company, region, industry, time period, and the like). Testimonial categories may be created for each service provider or set of service providers to allow them to organize incoming testimonials. Administrative features may also allow the sharing of testimonials to one or more sites, two or more sites, or even more sites. The administrative features may also include giving one administrator access to multiple service provider's accounts and/or multiple testimonials and/or multiple clients. As a testimonial comes in, an administrator may choose to display the testimonial on one or more widgets.

To work appropriately, the testimonial system may employ one or more computers, one or more databases, one or more websites, the Internet, and other items as can be foreseen by one of ordinary skill in the art.

While particular systems and methods of the present invention are illustrated and described herein, those skilled in the art will appreciate that various other changes and modifications may be made without departing from the spirit and scope of this invention. The following claims should be read to include such changes and modifications that are within the scope of this invention.

What is claimed is:

1. A testimonial system that gathers, stores, and/or shares testimonials, comprising:
an electronic testimonial-collection form that a client can fill out and submit to yield a completed testimonial;
a database for storing the completed testimonial; and
at least one means for the client, a service provider, the testimonial system, or combinations thereof to share the completed testimonial on at least one social networking website.

2. The system of claim 1, wherein the testimonial-collection form comprises a prompt asking the client to share the completed testimonial on a social networking site.

3. The system of claim 1, further comprising a service provider website and a widget feature that automatically updates the service provider's website when a client submits a new completed testimonial.

4. The system of claim 1, further comprising an electronic testimonial request form that a service provider can send to a client to solicit the client to fill out the testimonial-collection form.

5. The system of claim 1, further comprising a link the client can use to access the testimonial-collection form.

6. The system of claim 5, wherein the link is a specialized link.

7. The system of claim 1, wherein the testimonial system is web-based.

8. The system of claim 1, wherein the testimonial-collection form comprises a system to rate the service provider.

9. The system of claim 1, wherein the service provider can edit or remove completed testimonials.

10. The system of claim 1, further comprising an incentive system to encourage the client to fill out the testimonial-collection form and/or share the completed testimonial on a social networking website.

11. A method for gathering, storing, and/or sharing testimonials, comprising the steps of:
A. providing a testimonial-collection form to a client;
B. prompting the client to share a completed testimonial on a social networking site;
C. receiving a completed testimonial;
D. storing the completed testimonial in a database; and
E. sharing the completed testimonial on at least one social networking website.

12. The method of claim 11, wherein the completed testimonial is at least one website is selected from the group consisting of a social networking website, a service provider website, a testimonial system website, or combinations thereof.

13. The method of claim 11, wherein the testimonial-collection form comprises a prompt asking a client to share the completed testimonial on a social networking site.

14. The method of claim 11, further comprising using a widget feature to automatically update a service provider's website when a client submits a new completed testimonial.

15. The method of claim 11, further comprising sending an electronic testimonial request form to a client to solicit the client to fill out the testimonial-collection form.

16. The method of claim 11, further comprising providing a link the client can use to access the testimonial-collection form.

17. The method of claim 16, wherein the link is a specialized link.

18. The method of claim 11, wherein the testimonial system is web-based.

19. The method of claim 11, wherein the testimonial-collection form comprises a system to rate the service provider.

20. The method of claim 11, further comprising editing or removing completed testimonials.
